(19) United States
(12) Patent Application Publication
(10) Pub. No.: US 2011/0274487 A1
(43) Pub. Date: Nov. 10, 2011

(54) ASPHALT BINDER COMPOSITIONS AND METHODS OF USE

(75) Inventor: Laurence M. Sylvester, Tiburon, CA (US)

(73) Assignee: RAM TECHNOLOGIES, INC., Tiburon, CA (US)

(21) Appl. No.: 13/102,393

(22) Filed: May 6, 2011

Related U.S. Application Data
(60) Provisional application No. 61/332,173, filed on May 6, 2010.

(51) Int. Cl. E01C 11/24; B05D 7/00; C09D 191/00; C08L 95/00; C09D 195/00; C09D 121/00

(52) U.S. Cl. 404/72; 524/59; 106/273.1; 427/140

(57) ABSTRACT

Asphalt binder compositions are formed by combining asphalt with a reclaimed or re-refined oil. The boiling point of the oil may be greater than its flash point. The asphalt may be polymer modified or non-polymer modified. These asphalt binder compositions may be combined with aggregate and/or other matter (e.g., rubber particles) to form cold patch compositions suitable for various applications such as patching potholes, cracks or other defects in roads, driveways, roofs or other paved surfaces.

This patent application claims priority to U.S. Provisional Patent Application No. 61/332,173 filed May 6, 2010, the entire disclosure of which is expressly incorporated herein by reference.

### FIELD OF THE INVENTION

The present invention relates generally to the fields of chemistry, materials and civil engineering and more particularly to asphalt compositions and their methods of use.

### BACKGROUND OF THE INVENTION

Pursuant to 37 CFR 1.71(e), this patent document contains material which is subject to copyright protection. The copyright owner has no objection to facsimile reproduction of the entire patent document or the patent disclosure, as it appears in the Patent and Trademark Office patent file or records, but otherwise reserves all copyright rights whatsoever.

Asphalt binders in the form of cutbacks have been used as the basis for producing cold applied compositions for road repair as well as hot applied compositions for priming surfaces prior to the application of hot asphalt cement. Binders are typically modified to reduce viscosity with solvents or vacuum gas residuals from the refining process resulting in high Volatile Organic Content (VOC) leading to undesirable environmental consequences as well as creating safety issues and limiting the versatility of the liquid material. New methods for producing lubricating oils and fuels through pyrolysis of recycled tire rubber and from re-refining reclaimed lubricating oils and solvents have been invented with the uses primarily being restricted to marine or bunker fuel and as an asphalt flux to rejuvenate hard pen asphalts such as deasphaltized asphalt and hard bottoms, known in the industry as Zero Penetration Asphalts. Current asphalt cutbacks described in ASTM D 2399 are modified by the addition of solvents or fuel oils which present safety problems when mixed with aggregate in asphalt batch plants or continuous process plants under high temperature. As noted in the aforementioned ASTM D 2399, “the cut back asphalt may be applied at temperatures above its flashpoint. Caution, therefore, must be exercised at all times in handling these materials to prevent fire or an explosion.”

A typical cutback is described in U.S. Pat. No. 5,973,037 (Fields) wherein the invention is a cutback formed by blending an SBS (styrene-butadiene-stryene) polymer modified asphalt with mineral spirits to achieve viscosity modification. Mineral spirits, a typical and common asphalt viscosity modifier, has a typical flash point of 108° F. (42° C.) and a relatively high initial boiling point of 159° C. to 199° C. Another example is contained in U.S. Pat. No. 7,252,755 (Kiser, et al.), which describes a cutback asphalt formed with biodiesel materials such as soy bean oil derivatives (e.g., Soygold™ solvents available from Ag. Environmental Products, 12700 West Dodge Rd., Omaha, Nebr. 68154) as viscosity modifiers. Again, the modifiers used to achieve a cut back had flash points substantially lower than their initial boiling points. The table below indicates typical physical attributes for biodiesel additives used for the described purpose.

| | Flash | Boiling Point | Evaporation Rate |
|---|---|---|---|
| | Closed | (° F.) @ | @ 25° C. |
| Solvent | Cup(° F.) | 760 mm HG | (NBAC = 1.00) |
| SOYGOLD ™ 1000 | >300 | 632 | <0.006 |
| SOYGOLD ™ 1100 | >300 | 638 | <0.005 |
| SOYGOLD ™ 1500 | >300 | 634 | <0.005 |
| SOYGOLD ™ 2000 | >300 | 634 | |

Cold patch asphalt preparations are typically prepared by mixing an asphalt binder with aggregate (e.g., stones, sand, small rocks) at ambient temperature (i.e., without requiring heat). Cold patch asphalt preparations are often used to temporarily patch potholes, cracks and other road damage to avoid accidents and vehicle damage that could occur if the pothole, crack or other road damage were allowed to remain unrepaired until complete road resurfacing or other more permanent repairs can be ced. In some geographic areas, cold patch asphalt preparations are used in various seasons and various ambient temperatures.

U.S. Pat. No. 6,048,447 (Hayner et al.), describes compositions which comprise i) an asphalt component containing solvent-deasphalted bottoms, ii) a re-refined lube bottoms fraction, iii) an optional fluxing component, and iv) an optional vacuum bottoms component. The Hayner et al. invention further relates to a method of preparing the asphalt composition and a paving composition containing same. However, the materials described by Hayner et al. are generally seen to be paving grade asphalts. The entire disclosure of U.S. Pat. No. 6,048,447 (Hayner et al.) is expressly incorporated herein by reference.

There remains a need for the development of new asphalt binder combinations suitable for cold patch applications as well as other applications.

### SUMMARY OF THE INVENTION

In accordance with the present invention, there is provided an asphalt binder composition comprising: asphalt and reclaimed or re-refined oil. The boiling point of the oil may be greater than its flash point. The asphalt may be polymer modified or non-polymer modified. In embodiments that are polymer modified, a modifying polymer (e.g., styrene-butadyene-styrene (SBS) latex) may be added and/or polymers may be liberated from rubber particles by devulcanization of the rubber and the liberated polymers become combined with and modify the asphalt. Some embodiments may use a reclaimed oil made by pyrolysis of rubber, such as recycled or scrap rubber from tires and the like. Some embodiments may use a re-refined oil made by reprocessing previously used oils such as recycled lubrication oil.

Further in accordance, there are provided compositions that comprise an asphalt binder of the type summarized in the immediately preceding paragraph combined with at least an aggregate (e.g., stones, sand, rocks etc.) and/or other matter (e.g., rubber particles, crumb rubber, etc.). in some embodiments, these components may be mixed at ambient temperature (e.g., without adding heat) to form a cold patch material. The relative types and amounts of asphalt and oils contained in the asphalt binder may be varied to provide cold patch materials that are optimally suited for different temperatures and climatic conditions.

Still further in accordance with the invention, there is provided a method for repair of pothole, crack or other defect in a road, driveway, roof or other paved surface, said method comprising the step of at least partially filling the pothole, crack or other defect with a composition of the type summarized in the immediately preceding paragraph. In some applications, the composition may be applied to the pothole, crack or other defect at ambient temperature without added heat (e.g., as a cold patch process).

Still further aspects and details of the present invention will be understood upon reading of the detailed description and examples set forth herebelow.

### DETAILED DESCRIPTION OF THE INVENTION

The following detailed description and the accompanying drawings to which it refers are intended to describe some, but not necessarily all, examples or embodiments of the invention. The described embodiments are to be considered in all respects only as illustrative and not restrictive. The contents of this detailed description and the accompanying drawings do not limit the scope of the invention in any way.

In accordance with one aspect of the invention, there is provided a composition that comprises asphalt and reclaimed or re-refined oil. The boiling point of the re-refined oil is lower than its flash point.

In accordance with another aspect of the invention, the asphalt compositions of the present invention may be polymer modified or non polymer modified. In some embodiments, suitable polymer modification may be achieved by adding a polymer to the composition (e.g., the mixture of asphalt+reclaimed or re-refined oil) to effect polymer modification in situ. In other embodiments, all or a portion of the asphalt my be polymer modified before it is combined with the reclaimed or re-refined oil. Alternatively or additionally, polymer modification may be achieved by the addition and devlcanization of rubber, such as crumb or particulate rubber from recycled resources, thereby liberating or forming desirable poly ers from the rubber and incorporating them into the asphalt. Examples of this are described in U.S. Pat. Nos. 6,944,092 (Sylvester); 7,074,846 (Sylvester et al.) and 7,087,665 (Sylvester) as well as United States Patent Application Publication Nos. 2003/0018106 (Sylvester); 2004/0225036 (Sylvester et al.); 2005/0131113 (Sylvester)2005/0038141 (Sylvester et al.) and 2007/0249762 (Sylvester), the entire disclosure of each such patent and published patent application being expressly incorporated herein by reference. In embodiments where a polymer is added, or where all or part of the asphalt is polymer modified, any suitable polymer may be used. For example, a synthetic polymer that is useable for this purpose is styrene-butadiene copolymer (SBR) or styrene-butadiene-styrene (SBS) block copolymers available commercially under the trademarks Kraton or Hytrel. Non-limiting examples of other polymers that may be used include neoprenes, acrylic polymers, vinylacrylic polymers, acrylic terpolymers, nitriles, polyvinyl alcohols, polyvinyl acetates, vinyl acetate-ethylenes, vinyl ester copolymers, ethylene vinyl chloride, polyvinylidene chloride, butyl, acrylonitrile-butadiene, polyurethanes, silicones, and block copolymers such as styrene-isoprene (SIS), styrene-ethylene-vinyl acetate (SEVAS) and styrene acrylate.

The present invention provides safety advantages over other competitive technologies due to its use of high flash point, low viscosity/low boiling point re-refined lube oils from recycled products enable one to design new cutback asphalt blends without the low ignition properties and high volatility associated with high temperatures.

It is known that heavy fractions of oils derived from the pyrolysis of waste tires called Pyrolytic Bitumen (PB) and recycled lubrication oils called asphalt fluxes can be used as additives in road asphalt to reduce viscosity of highly distilled crude oils such as propane deasphaltized asphalt and heavy bottoms. PB's have also been identified as increasing compatibility of asphalts with styrene butadiene styrene for modification (C. Roy et al./J. Anal. Appl. Pyrolysis 51 (1999) 201-221).

Applicant has discovered, that fractions of these oils have been identified that provide not only rheological and compatibility benefits to virgin road asphalt but can be designed to provide significant safety margins while achieving specific performance properties. Fractions that have an initial boiling point (IBP) of 400° F. or better are unique in that they can be designed to also have low API gravity values and low viscosities at low temperatures but flash points of greater than 450° F. while initial boiling points are below their flash points. This cannot be achieved with similar vacuum distillates derived from refined crude oil without the addition of other substances such as chlorine. Typical lube oil products that fall within these parameters include; D/K Asphalt Flux, Domenno/Kerdoon, Compton, Calif. with an API gravity of 22.50-23.5 an kinematic Vis @ 100° Cl of 22.5 cst-24.5 cst, an IBP of 441° F. and a Cleveland Open Cup (COC) flash point of 500° F.-520° F., and a specially designed distillate fraction from Bango Oil, Fallon, Nev., Bango 24, has an IBP of less than 400° F. a kinematic viscosity @ 60° C. (140° F.) of 150 cst, a flash point of greater than 450° F. and an API gravity of 24. As a comparison, Asphalt Extender manufactured by SafetyKleen, Plano Tex. and a product manufactured from recycled motor oil has a flash point of 500° F. and boiling point of 800° F. Similarly, Raffene 2000L, a product manufactured by San Joaquin Refining, Bakersfield, Calif. from crude oil and also used as an asphalt extender has a COC flash point of 400° F.-420° F. and an initial boiling point of 550° F. It is the unique properties of the former materials with products designed to be highly liquid product at temperatures well below their flash points that enable the current invention.

Due to their potential to catch fire at temperatures at their designed flash point (as high as (107° C.) 225° F. for an slow curing type) typical cutbacks as designed in accordance with current ASTM standards when exposed to high temperatures, emit high volumes of volatile organic compounds that contaminate the atmosphere. The present invention, through the incorporation of new lubrication oils derived from these new technologies provide an ability to design improved cutback asphalt by achieving low viscosities, increased flash points and safety with virtually little or no VOC component at high temperatures and no reduction in performance.

In some embodiments of the invention, lower temperature antistrip additives may be added to the asphalt cutback to insure that the asphalt blend will adhere thoroughly to aggregate. This results in the emission of noxious fumes when blended. Addition of polymer modification in the present invention alleviates this requirement by increasing the Tension Stress Result and adhesion to aggregate without the addition of easily evaporated base solvents and a reduction in noxious odors.

This invention provides a method for the manufacture of an improved bituminous binder comprising an asphalt binder, a high temperature a low VOC oil derived from re-refined recycled lubricating oil or recycled rubber with a flash point of between 450 F and 600 F and a Kinematic viscosity of between 50 and 100 stokes at 140 F (60 C). The invention may also include a rubber polymer modified asphalt component. The rubber polymer modified asphalt is preferably modified with rubber from reclaimed resources.

### Example 1

61.9 parts by weight of PG 64-16 asphalt (NuStar Energy, Pittsburg, Calif.) was blended together under low shear with 26.5 parts by weight of oil Flux derived from reclaimed and re-refined lubrication oil (Demenno Kerdoon, Compton, Calif.) together with 11.6 parts by weight of Polymer Modified Asphalt PG 64-28 (NuStar Energy, Pittsburg, Calif.). Viscosity of this blend at 225° F. was 142 cps.

### Example 2

39 parts by weight of PG 64-16 asphalt (NuStar Energy, Pittsburg, Calif.) was blended together under low shear with 49 parts by weight of an oil Flux derived from reclaimed and re-refined lubrication oil (Bango Oil, Fallon, Nev.) together with 12 parts by weight of Polymer Modified Asphalt PG 64-28 (NuStar Energy, Pittsburg, Calif.). Viscosity of this blend at 275° F. was 47.5 cps.

### Example 3

An all weather cold patch asphalt binder base is prepared by blending, under low shear, about 49.1 parts by weight of PG 64-16 asphalt (NuStar Energy, Pittsburg, Calif.) with about 40.2 parts by weight of Asphalt Flux derived from reclaimed and re-refined lubrication oil (Demenno Kerdoon, Compton, Calif.) together with about 11.60 parts by weight of Polymer Modified Asphalt PG 64-28 (NuStar Energy, Pittsburg, Calif.). Viscosity of this blend at 225° F. was 52 cps.

This asphalt composition was combined with aggregate to yield two gradations of asphalt aggregate blend, a dense and a coarse graded blend. The application rate of the liquid asphalt composition was 6.5 and 5.9% by weight of the total blend, respectively.

A dense grade mix was blended using 850 grams (93.5 parts by weight) of an aggregate meeting the California Department of Transportation specification for ⅜ inch HMA aggregate Gradation for Types A and B together with 30.8 grams of the asphalt composition. This blend was then visually inspected for coating and all aggregate was fully coated. The cohesion of aggregate together was tested by packing into brick forms and then released from the forms and placed on a surface at ambient temperatures for 30 days.

The aggregate asphalt blend retained its form and did not slump. A boil off test was performed to determine the percentage of coating loss. 50 grams of the aggregate asphalt blend was take from the brick and was placed in a 300 ml glass beaker containing 200 ml of distilled water. This was placed on a hot plate and brought to a vigorous boil for a period of 2 minutes. The bitumen residue that floated on the surface at the end of that period was “very slight.” The water was decanted from the beaker and the remaining coated aggregate was placed on white filter paper until remaining water had evaporated from the mixture. A visual inspection of the aggregate asphalt composition blend would rate the approximate percentage of uncoated aggregate as none. This test was a modified test based on the Missouri Department of Transportation's Test 106.7.12 TM-12, Stripping of Bituminous-Aggregate Mixtures, Boil Method for Seal Coats. And was used to determine the ability of the composition to resist stripping from the aggregate.

### Example 4

A coarse graded mix was blended using 850 grams (94.1 parts by weight) of an aggregate blend consisting of 95%-100 aggregate retained on a ⅜″ sieve and no greater than 5% passing through a 200 mesh sieve together with 55 grams (5.9 parts by weight) of the all weather cold patch binder.

This blend was then visually inspected for coating and all aggregate was fully coated. The cohesion of aggregate together was tested by packing into brick forms and then released from the forms and placed on a surface at ambient temperatures for 30 days. The aggregate asphalt blend retained its form and did not slump. A boil off test was performed to determine the percentage of coating loss. 50 grams of the aggregate asphalt blend was take from the brick and was placed in a 300 ml glass beaker containing 200 ml of distilled water. This was placed on a hot plate and brought to a vigorous boil for a period of 2 minutes. The bitumen residue that floated on the surface at the end of that period was “slight.” The water was decanted from the beaker and the remaining coated aggregate was placed on white filter paper until remaining water had evaporated from the mixture. A visual inspection of the aggregate asphalt composition blend would rate the approximate percentage of uncoated aggregate as none. This test was a modified test based on the Missouri Department of Transportation's Test 106.7.12 TM-12, Stripping of Bituminous-Aggregate Mixtures, Boil Method for Seal Coats and was used to determine the ability of the asphalt composition to resist stripping from the aggregate.

### Example 5

The following table shows examples of formulations for cold patch asphalt preparations intended for use in different climactic conditions. Formulation No. 1 is desirable for use in summer conditions or where temperatures range from about 77° F. (25° C.) to about 120° F. (490 C). Formulations No. 2 and 3 are cold weather patch preparations suitable for use in temperatures from below 32° F. (0° C.) to about 77° F. (25° C.).

| | Formu- | Formu- | Formu- | |
|---|---|---|---|---|
| | lation | lation | lation | |
| Component | No. 1 | No. 2 | No. 3 | Source |
| PG64-22 | 37.5% | 16.24 | 24.45% | San Joaquin Refinery, |
| Asphalt | | | | Bakersfieid, CA |
| PG 64-28PM | 14.15% | 6.27% | 9.45% | San Joaquin Refinery, |
| Asphalt | | | | Bakersfield, CA |
| DMK Re- | 43.35% | 77.49% | 66.10% | Demenno Kerdoon, |
| refined Oil | | | | Compton, CA |

It is to be appreciated that the invention has been described hereabove with reference to certain examples or embodiments of the invention but that various additions, deletions, alterations and modifications may be made to those examples and embodiments without departing from the intended spirit and scope of the invention. For example, any element or attribute of one embodiment or example may be incorporated into or used with another embodiment or example, unless otherwise specified of if to do so would render the embodiment or example unsuitable for its intended use. Also, where the steps of a method or process have been described or listed in a particular order, the order of such steps may be changed unless otherwise specified or unless doing so would render the method or process unworkable for its intended purpose. All reasonable additions, deletions, modifications and alterations are to be considered equivalents of the described examples and embodiments and are to be included within the scope of the following claims.

What is claimed is:

1. An asphalt binder composition comprising: asphalt and reclaimed or re-refined oil.

2. A composition according to claim 1 wherein the boiling point of the oil is greater than its flash point.

3. A composition according to claim 1 wherein the asphalt is not polymer modified.

4. A composition according to claim 1 further comprising a polymer.

5. A composition according to claim 1 wherein the asphalt is polymer modified.

6. A composition according to claim 1 wherein the asphalt comprises a combination of polymer modified asphalt and non-polymer modified asphalt.

7. A composition according to claim 1 wherein the asphalt comprises from about 40 to about 65 parts by weight non-polymer modified asphalt in combination with from 0 to about 24 parts by weight of polymer modified asphalt and

8. The composition of claim 1 wherein the asphalt has a PG grade of between about 64-16 to about 52-28

9. A composition according claim 1 wherein the improved asphalt binder has a viscosity of between 25 centipoises and 200 centipoises at 225° F.

10. A composition according claim 1 wherein the reclaimed oil is derived from the pyrolysis of recycled tires.

11. A composition according claim 1 wherein the re-refined oils is derived from reprocessing recycled lubrication oil.

12. A composition according claim 1 wherein the polymer modified asphalt contains at least 5 parts by weight 20 parts by weight of recycled tire rubber.

13. A composition according claim 4 wherein the re-refined oil has an American Petroleum Institute gravity rating is from between about 10 API and about 30 API.

14. A composition according claim 4 wherein the re-refined oil has an American Petroleum Institute gravity rating from between 15 API to 28 API.

15. A composition comprising an asphalt binder according to claim 1 combined with an aggregate.

16. A composition according to claim 15 wherein the asphalt binder is combined with the aggregate at ambient temperature without added heat.

17. A composition according to claim 15 further comprising rubber particles.

18. A method for repair of a pothole, crack or other defect in a road, driveway, roof or other paved surface, said method comprising the step of:
at least partially filling the pothole, crack or other defect with a composition according to any of claims 16-18.

19. A method according to claim 18 wherein the composition is applied to the pothole, crack or other defect at ambient temperature without added heat.
